(19) United States
(12) Patent Application Publication
(10) Pub. No.: US 2026/0008431 A1
(43) Pub. Date: Jan. 8, 2026

(54) System For Detecting Improper Use Of A Seatbelt

(71) Applicant: Caterpillar Inc., Peoria, IL (US)

(72) Inventors: Kalaivani Ashokkumar, Chennai (IN); Sreekanth Chakravarthy Gomadam, Chennai (IN); Sathish Kumar Loganathan, Chennai (IN); Ruthra Karuppaiah, Salem (IN); Gokul Krishna N, Kerala (IN)

(21) Appl. No.: 19/160,305

(22) PCT Filed: Feb. 21, 2024
(86) PCT No.: PCT/US2024/016595

§ 371 Date: Aug. 27, 2025

(30) Foreign Application Priority Data
Mar. 9, 2023 (IN) 202311015596

(51) Int. Cl. B60R 22/48; B60R 22/12

(52) U.S. Cl. CPC B60R 22/48; B60R 22/12; B60R 2022/4816; B60R 2022/4825; B60R 2022/4841; B60R 2022/485; B60R 2022/4858; B60R 2022/4891

(57) ABSTRACT

A system for detecting improper use of a seatbelt on a seat in a work machine is disclosed. The system comprises: a plurality of detection devices disposed on a plurality of locations within a cab of the work machine; a detection strip/tape on a strategic location of the seatbelt and configured to be detected by the plurality of detection devices; a controller coupled in communication to the plurality of detection devices, the controller configured to: receive input signals from the plurality of detection devices, wherein at least one input signal is indicative of improper use of the seatbelt; and communicate control signals to at least one operational system associated with the work machine upon receipt of an at least one input signal indicative of improper use of the seatbelt.

### TECHNICAL FIELD

The present disclosure generally relates to seatbelt systems in work machines, and more particularly relates to a system for detecting improper use of a seatbelt.

### BACKGROUND

Use of work machines in environments such as mining, construction, or other commercial purpose vehicles, and passenger automobiles, can pose risks to occupants, i.e., operator, driver, or passenger safety. Therefore, when occupants position themselves in respective seats of the vehicle, these occupants are required to wear a seatbelt during operation for road regulations. Current seat belt systems are designed for use such that an occupant may or may not use the seat belt causing little to no sense of individual accountability and responsibility on the part of the occupant from a road regulatory and compliance perspective. Moreover, when occupants fail to wear seatbelts properly, i.e. in the correct manner for the intended purpose of limiting risk of injury to the occupants, the purpose of the seatbelt in reducing risk of injury is removed.

In many cases, it has been observed that occupants have been wearing the seatbelt improperly at least partly due to discomfort. As the seatbelt may rub over their body and neck especially when the occupant performs long hours of machine operation or even simply sitting in the vehicle while the seatbelt is worn. Although some seatbelt designs may be uncomfortable, means for limiting risk of injury to the occupants of the vehicle is needed especially during operation of the vehicle and therefore, the seatbelt must be worn properly for to comply with both safety regulations and other legal requirements even though such safety regulations or legal requirement may vary from place to place.

Conventional seatbelt systems may be able to detect whether the seatbelts are buckled, as a primitive and basic way for detecting proper seatbelt usage. However, threshold for such detection vis-à-vis the buckling of seatbelt alone is usually low and therefore, easily bypassed. Occupants have been known to willfully trick such conventional seatbelt systems into thinking that the seatbelt is buckled to avoid wearing the seatbelt properly. In some cases, occupants have been known to trick such conventional seatbelt systems by using a dummy clip that fit into the buckle to fool a seatbelt system and perhaps, even an associated warning system. In some cases, occupants may fool such conventional seatbelt systems by “pseudo buckling”—i.e., running the seatbelt behind the occupant's rear side and in front of the seat, or stated differently, running the seatbelt between a backside of their body and the seat, while continuing to ensure that a tongue, or a latch, of the seatbelt is engaged with the buckle. In yet other cases, another form of pseudo-buckling can include running the seatbelt altogether along the backside of the seat i.e., facing middle row passengers, while also ensuring that the tongue/latch on the seatbelt is engaged with the buckle. In yet other cases, there is a possibility for an operator to combine and use more than one form of pseudo-buckling to work around the detection of improper use of the seatbelt. Such instances can include, for example, overriding the seatbelt detection system by routing the seatbelt, from a retractor body, over the backside of the occupant's seat, or by using a dummy clip, potentially in tandem with improper seatbelt routing.

Some manufacturers of seatbelts previously attempted to create systems that ensure proper seatbelt usage but have failed to detect when the seatbelt is either placed behind an occupant's body or along the rear side of the occupant's seat. For example, U.S. Pat. No. 10,471,930 (hereinafter referred to as the “'930 reference”) discloses a seatbelt system that detects improper use of a seatbelt. The '930 reference discloses detecting metallic/magnetic components located within the portion of the seatbelt corresponding to the chest using a shoulder belt sensor and lap belt sensor. However, it can be seen that the '930 reference provides for a seatbelt usage system that fails to detect improper conditions and still allows for other forms of pseudo buckling. The sensors are disposed within the occupant seat, and are configured to sense the sensible elements when the sensible elements are in proximity to the sensors, as an indication that the occupant does not properly wear the restraint device. However the '930 still allows for an operator to fool the system by routing the seatbelt along the rear side of the seat's backrest and requires the sensors to be on or within the seat.

In light of the aforementioned shortcomings, or drawbacks, associated with use of conventionally designed seatbelt systems, there exists a need for a seatbelt system that detects when a seatbelt is improperly used.

### SUMMARY

In one aspect of the present disclosure, a system for detecting proper use of a seatbelt on a seat in a work machine is disclosed. The system comprises: a plurality of detection devices; a detection strip on a portion of the seatbelt configured to be detectable by the plurality of detection devices; and a controller configured to receive input signals from the plurality of detection devices and configured to communicate a control signal to at least one operational system when detecting pseudo buckling and improper seatbelt use events during operation of the work machine.

In accordance with another aspect of the disclosure, a work machine is disclosed. The work machine comprises: a frame; an engine; ground engaging elements supporting the frame; a cab; a seat; a seatbelt having a latch plate configured to connect to a buckle; a seatbelt retractor; a detection strip on a portion of the seatbelt; a plurality of detection devices disposed on a plurality of locations within the cab of the work machine; and a controller. The controller is communicably coupled to the plurality of detection devices. The controller is configured to: receive input signals from the plurality of detection devices; and communicate control signals to at least one operational system when receiving input signals of improper seatbelt usage.

In accordance with another aspect of the disclosure, a method for detecting pseudo buckling during operation of a work machine is disclosed. The method comprises: providing a seatbelt usage system to a seat in the work machine; activating the work machine to an operational state thereby activating the seatbelt usage system; monitoring, via an occupant presence sensor in the seatbelt usage system, for the occupant seated on the seat; detecting, via a plurality of detection devices in the seatbelt usage system for pseudo buckling; and controlling an operational system, via a controller in the seatbelt usage system, to enforce proper usage of the seatbelt.

These and other aspects and features of the present disclosure will be better understood upon reading the following detailed description when read in conjunction with the accompanying drawings.

### BRIEF DESCRIPTION OF THE DRAWINGS

FIG. 1 is a perspective view of a work machine having a seat in a cab, according to one embodiment of the disclosure.

FIG. 2 is a perspective of a front view of a seat with a seatbelt system, according to one embodiment of the disclosure.

FIG. 3 is schematic of the seatbelt system on a front side of a seat near a sidewall in a work machine, according to one embodiment of the disclosure.

FIG. 4 is a perspective of a rear view of a seat with a seatbelt system, according to one embodiment of the disclosure.

FIG. 5 is a schematic of a front view of a seat with an occupant on the seat near a sidewall of a vehicle, according to one embodiment of the disclosure.

FIG. 6 is a perspective of a front view of a seat with a seatbelt system, according to an embodiment of the disclosure.

FIG. 7 is a schematic of a front view of a seat with a 3-point or Y-shaped seatbelt with an occupant on the seat near a sidewall of a vehicle, according to one embodiment of the disclosure.

FIG. 8 is a schematic of a front view of a seat with a 2-point or lap belt seatbelt with an occupant on the seat using a lap seatbelt, according to an embodiment of the disclosure.

FIG. 9 is a perspective of a front view of a seat with a shoulder seatbelt, according to an embodiment of the disclosure.

FIG. 10 is a perspective of a rear view of a seat with a shoulder seatbelt, according to an embodiment of the disclosure.

FIG. 11 is an illustration of a front view of a seat from an imaging device vantage point, according to an embodiment of the disclosure.

FIG. 12 is a schematic of a seatbelt usage system for a seat in a work machine, according to one embodiment of the disclosure.

FIG. 13 is a flow chart detecting pseudo-buckling of the seatbelt usage system in a work machine, according to one embodiment of the disclosure.

FIG. 14 is a flow chart detecting pseudo-buckling of the seatbelt usage system in a work machine, according to another embodiment of the disclosure.

FIG. 15 is a flow chart detecting pseudo-buckling of the seatbelt usage system in a work machine, according to another embodiment of the disclosure.

FIG. 16 is a system flow chart detecting pseudo-buckling of the seatbelt usage system in a work machine, according to another embodiment of the disclosure.

FIG. 17 is a system flow chart detecting pseudo-buckling of the seatbelt usage system in a work machine, according to another embodiment of the disclosure.

FIG. 18 is a flow chart of a method of detecting pseudo buckling of a seatbelt, according to one embodiment of the disclosure.

The figures depict one embodiment of the present disclosure for purposes of illustration only. One skilled in the art will readily recognize from the following discussion that alternative embodiments of the structures and methods illustrated herein may be employed without departing from the principles described herein.

### DETAILED DESCRIPTION

Referring now to the drawings, and with specific reference to the depicted example, a work machine 100 is shown, illustrated as an exemplary backhoe loader. Backhoe loaders are heavy equipment designed to move earth material from the ground or landscape at a dig site in the construction and agricultural industries. While the following detailed description describes an exemplary aspect in connection with the backhoe loader, it should be appreciated that the description applies equally to the use of the present disclosure in other work machines including but not limited to excavators, front-end loaders, skid steers, wheel loaders, earth-moving machines, articulated wheel loaders, tractors, and commercial purpose machines, as well as automotive vehicles, sedans, SUVs, trucks, semi-trucks, and the like.

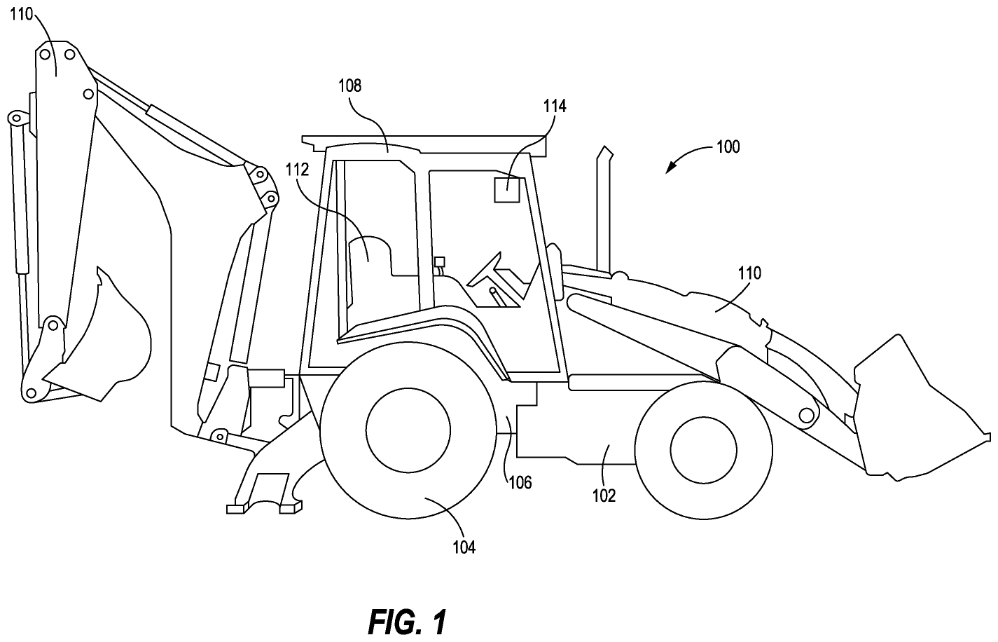

Referring now to FIG. 1, the work machine 100 comprises a frame 102. The frame 102 is supported on ground engaging elements 104, illustrated as continuous tracks. It should be contemplated that the ground engaging elements 104 may be any other type of ground engaging elements 104 such as, for example, wheels, etc. The work machine 100 further includes an engine 106 in the frame 102, a cab 108 for occupants or operator personnel, and a working mechanism 110 extending from the frame 102 for conducting work, such as, for example, excavating landscapes or otherwise moving earth, soil, or other material at a dig site. The frame 102 provides support to the cab 108 and other drive train elements, such as, but not limited to, axles, wheels, engine, and other types of components known to persons skilled in the art. The frame 102 may be an upper swiveling body common with excavators and work machines in the agricultural and construction industries. Additionally, the cab 108 in the work machine 100 may be provided with a seat 112, an imaging device 114.

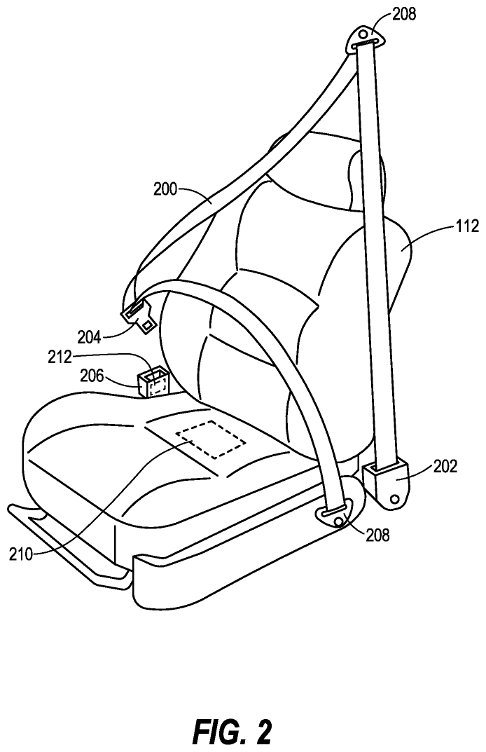

Referring now to FIG. 2, the seat 112 is illustrated, in one embodiment of the disclosure commonly found in automotive vehicles, trucks, and work machines. The seat 112 comprises a seatbelt 200, a seatbelt retractor 202, a latch plate 204, a buckle 206, a plurality of pillar loops 208, a presence sensor 210 for detecting an occupant on the seat 112, and a buckle sensor 212 embedded inside the buckle 206 to detect buckling of the seatbelt 200. The seatbelt retractor 202 is provided to keep the seatbelt 200 in a contracted position for safety while also configured with adjustable features for comfort of occupants on the seat 112. More than one seat 112 may be provided for a plurality of occupants, drivers, and passengers in vehicles, trucks, and work machines. The seatbelt 200 may be various common types of seatbelts such as a lap belt, a slash belt, a shoulder belt, a three-point belt, a Y-shaped belt, a built-in-seat belt, or a five-point harness used in various applications such as work machines, automotive cars, buses, trucks, and race cars.

The presence sensor 210 may be a pressure sensor, and the like, which may be configured to detect varying degrees of weight applied on the seat 112. For example, a package or groceries placed on the seat 112 may not trigger the presence sensor 210 but a child or toddler may be detected when sitting on the seat 112. The presence sensor 210 is configured to distinguish between an occupant and another object weighing less than an average-sized occupant when seated on the seat 112. The buckle sensor 212 is embedded inside the buckle 206 and configured to detect buckling of the seatbelt 200 when the latch plate 204 is inserted inside the buckle 206.

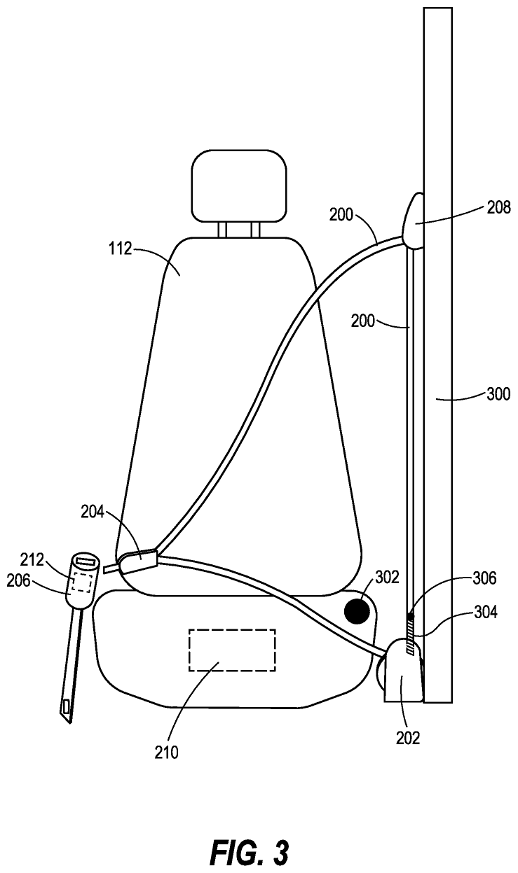

Referring now to FIG. 3, a front side view of the seat 112 is illustrated, in one embodiment of the disclosure commonly found in automotive vehicles, trucks, and work machines. The seat 112 may be situated near a sidewall 300 of the cab 108. The seatbelt 200 mounted to the sidewall 300 via the plurality of pillar loops 208 and configured to extend across the seat 112 and into the buckle 206 positioned on the opposite side of the seat 112 distal from the sidewall 300. The seat 112 may further comprise a proximity sensor 302 mounted at the lowest possible mounting point and disposed to a side of the seat 112 to detect a detection strip 304 positioned on the seatbelt 200 at a strategic location 306. The strategic location 306 may be determined on the seatbelt 200 by running along a front side of an unoccupied seat and the tongue of the latch plate 204 on the seatbelt 200 is fastened into the buckle 206 across the empty seat 112, so that the lowest point on the seatbelt 200 may be calculated and fixed closest to the seatbelt retractor 202. The detection strip 304 may be a metallic strip/tape made of ferrous metals, and the like. The detection strip 304 may also be embedded with RFID tags, as generally known in the arts.

The proximity sensor 302 and the detection strip 304 is configured and calibrated to be positioned so that the proximity sensor 302 detects the detection strip 304 when the seatbelt 200 is properly worn by the average occupant of a vehicle. The detection strip 304 may enter and exit the seatbelt retractor 202 with the seatbelt 200. The detection strip 304 may be provided at varying degrees of length to support varying calibrations.

The proximity sensor 302 may include a plurality of sensors that generally detect an object, or other signal, upon entering the field of view of the proximity sensor 302. A variety of possible proximity sensors, inertial measurement unit (IMU) sensors, ultrasonic sensors, and the like may be used. There are several different positions that the proximity sensor 302, as one or many proximity sensors, may be mounted to the lowest possible mounting point and disposed to a side of the seat 112, on the sidewall 300, and interior of the cab 108 of the work machine 100, such as the lowest mounting points in the cab 108 and/or on the sidewall 300. In some embodiments, the mounting point may be positioned below the lowest portion or above the highest portion of the seat 112.

The proximity sensor 302 may be mounted strategically away from the occupant to not be visible because occupants have been known to place blockers on viewable seatbelt-related sensors. This may depend, in part, on the design and assembly of the work machine 100, the configuration of the seat 112, the position of the seat 112 in the work machine 100, and distance of the seat 112 to a sidewall 300, if available. The proximity sensor 302 may range in complexity from simplistic proximity devices to more complicated devices which include their own onboard computer processors, wired or wireless technology, memory, and the communication adapters. The proximity sensor 302 may be positioned in a location so that the occupant of the work machine 100 may be unaware of the existence of the proximity sensor 302.

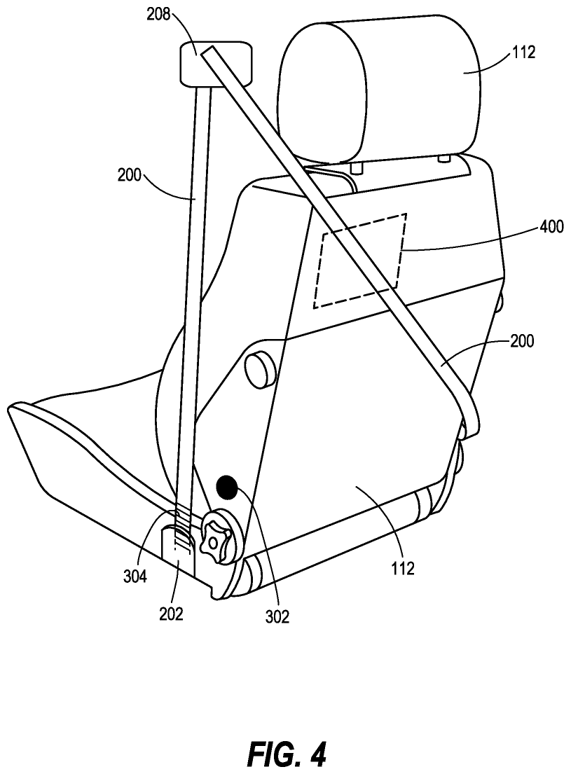

Referring now to FIG. 4, a rear view of the seat 112 is illustrated, in one embodiment of the disclosure. The seat 112 further comprises an infrared sensor 400 for detecting when the seatbelt 200 is wrapped around the backside of the seat 112. Occupants may often lock the seatbelt 200 in the buckle 206 but pull the remaining portion of the seatbelt 200 around the backside of the seat 112. The infrared sensor 400 may be placed near the shoulder area on the backside of the seat 112 to detect the seatbelt 200 when an occupant attempts to avoid proper seatbelt usage by wrapping the seatbelt 200 behind the seat 112. The infrared sensor 400 may be a short-range infrared sensor or a photoelectric sensor, as generally known in the arts.

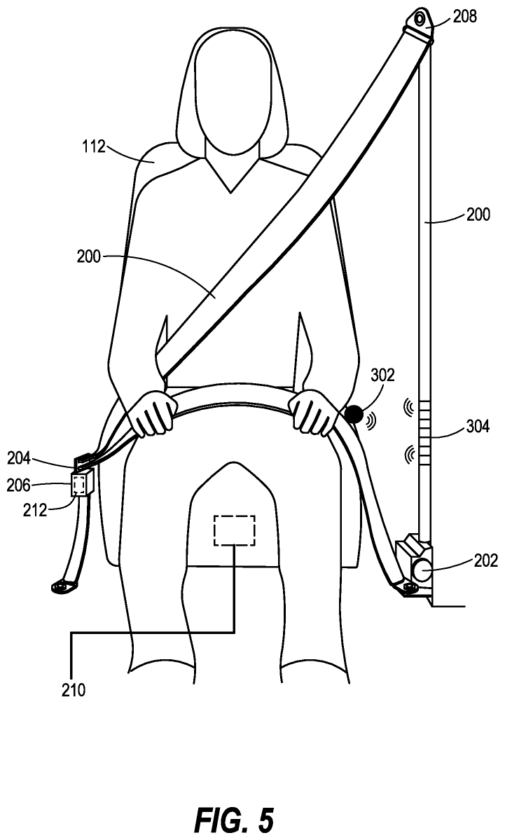

Referring now to FIG. 5, a front side view of the seat 112 with an occupant wearing the seatbelt 200 illustrated as a Y-shaped belt or three-point belt, in one embodiment of the disclosure. The seatbelt 200 is extended across the seat 112 and into the buckle 206 positioned on the opposite side of the seat 112 and worn on the front side of an occupant. When the occupant wears the seatbelt 200 and buckles the latch plate 204 into the buckle 206, the detection strip 304 on the seatbelt 200 extends out of the seatbelt retractor 202 and into the field of view of the proximity sensor 302. The proximity sensor 302 is positioned in the cab 108 and the detection strip 304 is positioned on the seatbelt 200 so that when the seatbelt 200 is worn by the occupant the detection strip 304 is exposed and may be detected in the field of view of the proximity sensor 302. The proximity sensor 302 and the detection strip 304 may be further configured and calibrated so that the proximity sensor 302 detects the detection strip 304 when the seatbelt 200 is properly worn by an occupant of the work machine 100. The detection strip 304 may also enter and exit the seatbelt retractor 202 with the seatbelt 200 for exposing itself to the proximity sensor 302 during proper seatbelt usage. The detection strip 304 may be provided at varying degrees of length to support varying configurations. The detection strip 304 may be webbed within the seatbelt 200. The detection strip 304 may also be camouflaged or incorporated into the seatbelt 200 so that it is not noticeable to the human eye, as generally known in the arts.

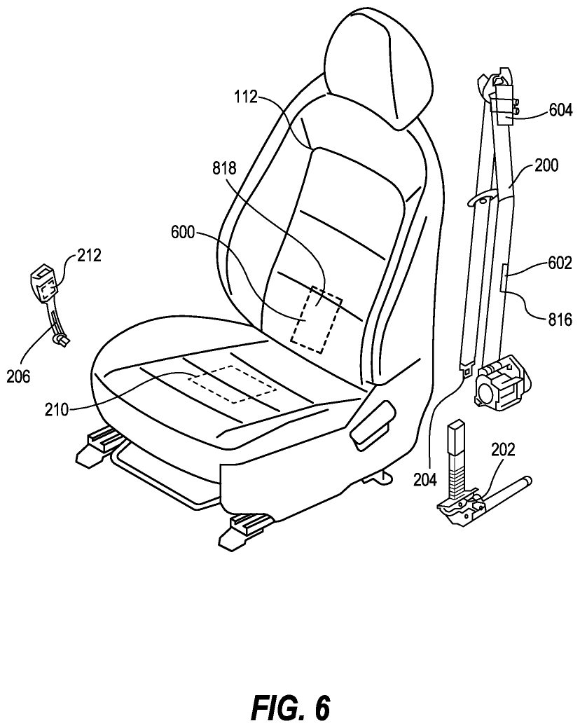

Referring now to FIG. 6, a perspective of a front view of the seat 112 with the seatbelt 200 is illustrated, according to an embodiment of the disclosure. The seat 112 may further include an RFID antenna 600, an RFID tag 602, and a tension sensor 604. The RFID antenna 600 is positioned on the seat 112 and the RFID tag 602 is positioned on the seatbelt 200 so that the RFID antenna 600 detects whether the seatbelt 200 is buckled on the front side of the seat 112 or from behind on the rear side of the seat 112. When the RFID antenna 600 does not detect the RFID tag 602, the RFID antenna 600 may communicate to the controller 802 that the seatbelt 200 is buckled properly over the occupant's body. The RFID tag 602 may be a passive RFID tag embedded on the seatbelt 200 and gets power from the RFID antenna 600 situated on the seat 112. The RFID antenna 600 may also be referred as an RFID receiver that can provide power to the RFID tag 602, as generally known in the arts. When the RFID tag 602 is close to the seat 112, the RFID antenna 600 detects when the seatbelt 200 is placed behind the seat or behind the occupant in front of the seat 112, referred herein as “pseudo buckling.”

The tension sensor 604 is provided on the seatbelt 200 to measure the tension of the seatbelt 200 to be used for indicating buckling of the seatbelt 200 over an occupant on the seat 112. The tension sensor 604 may be provided on the seatbelt 200 which is closer to the seatbelt retractor 202 for 2-point or lap-belt systems whereas the tension sensor 604 may be provided over the seatbelt 200 which is closer to the plurality of pillar loops 208 for 3-point or Y-shaped seat belt systems. The tension sensor 604 may be placed on the seatbelt 200 to measure the tension of the seatbelt 200. If the tension of the seatbelt 200 falls below a certain tension threshold, then the tension sensor 604 may detect that the seatbelt 200 is not worn over the occupant. If the tension of the seatbelt 200 is detected above a certain tension threshold, then the tension sensor 604 may detect that the seatbelt 200 is buckled over the occupant. The tension sensor 604 may also be incorporated within, inside, or as a part of the seatbelt retractor 202. The tension sensor 604 may be incorporated on the seatbelt 200 close to the seatbelt retractor 202 for 2-point & lap belt systems and also incorporated over the seatbelt 200 proximate or close to the plurality of pillar loops 308 for 3-point & Y-shaped seatbelt systems, which may remove the need for the infrared sensor 400 on the backside of the seat 112 while operating with the proximity sensor 302 for detecting pseudo buckling, as shown in FIGS. 1-6.

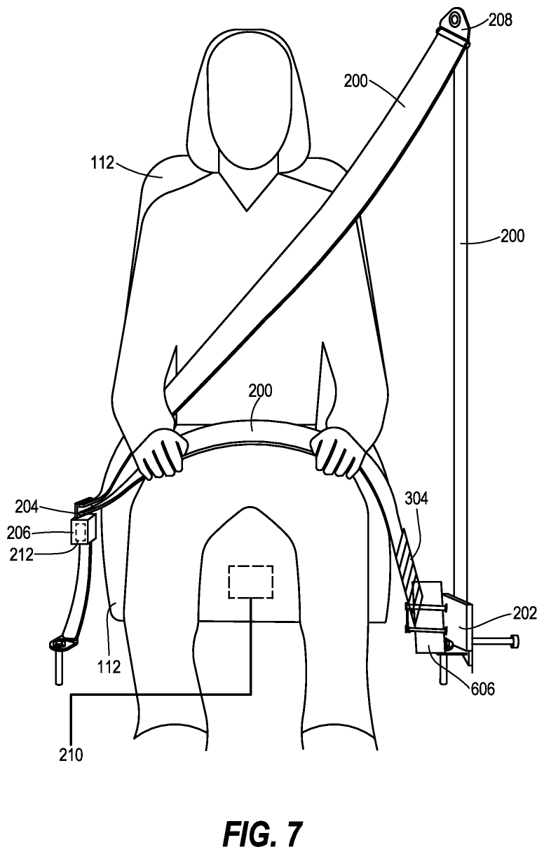

Referring now to FIG. 7, a front side view of the seat 112 with an occupant wearing the seatbelt 200 illustrated as a Y-shaped belt or three-point belt, in another embodiment of the disclosure. The seatbelt 200 is extended across the seat 112 and into the buckle 206 positioned on the opposite side of the seat 112 and worn on the front side of an occupant. When the occupant wears the seatbelt 200 and buckles the latch plate 204 into the buckle 206, the detection strip 304 on the seatbelt 200 extends out of the seatbelt retractor 202 and into the field of view of the proximity sensor 302. An integrated sensor 606, a proximity cum tension sensor, having the proximity sensor 302 and the tension 604 integrated into the integrated sensor 606, is positioned proximate to the seatbelt retractor 202. The detection strip 304 is positioned on the seatbelt 200 so that when the seatbelt 200 is worn by the occupant the detection strip 304 is exposed and may be detected in the field of view of the integrated sensor 606. The integrated sensor 606, the proximity sensor 302 in the integrated sensor 606, and the detection strip 304 may be further configured and calibrated so that the proximity sensor 302 detects the detection strip 304 when the seatbelt 200 is properly worn by an occupant of the work machine 100. The detection strip 304 may also enter and exit the seatbelt retractor 202 with the seatbelt 200 for exposing itself to the proximity sensor 302 during proper seatbelt usage. The detection strip 304 may be provided at varying degrees of length to support varying configurations.

The integrated sensor 606, also having the tension sensor 604 incorporated with the proximity sensor 304, may be provided on the seatbelt 200 to measure the tension of the seatbelt 200. If the tension of the seatbelt 200 falls below a certain tension threshold, then the tension sensor 604 may detect that the seatbelt 200 is not worn over the occupant. If the tension of the seatbelt 200 is detected above a certain tension threshold by the integrated sensor 606, then the integrated sensor 606 may detect that the seatbelt 200 is buckled over the occupant, via the tension sensor 604. The integrated sensor 606 supports in detecting pseudo buckling and detection of using the seatbelt 200 along the backside of the seat 112, because the tension sensor 604 may be configured to determine a backside tension threshold when the seatbelt 200 is placed on the backside of the seat 112, as shown in FIG. 7.

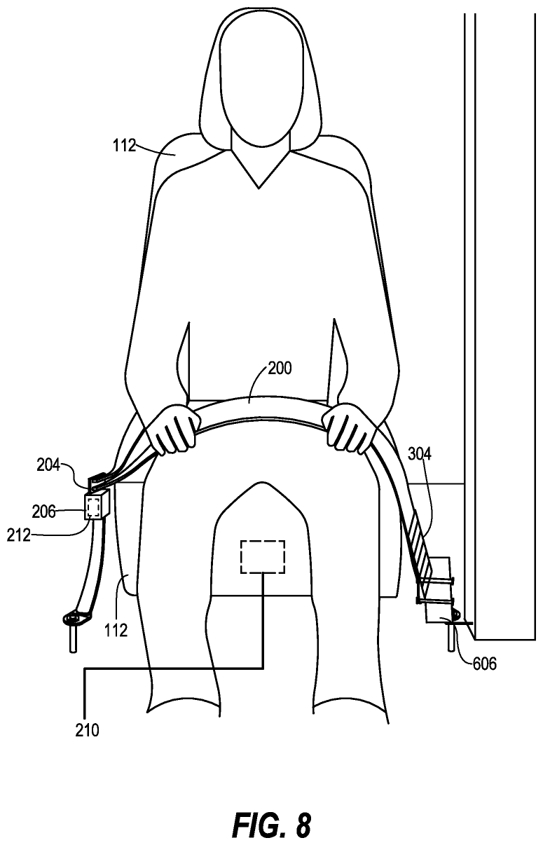

Referring now to FIG. 8, a front side view of the seat 112 with an occupant wearing the seatbelt 200 illustrated as a lap belt, in another embodiment of the disclosure. The seatbelt 200 is extended across the seat 112 and into the buckle 206 positioned on the opposite side of the seat 112 and worn across the lap of an occupant. When the occupant wears the seatbelt 200 and buckles the latch plate 204 into the buckle 206, the detection strip 304 on the seatbelt 200 extends out of the seatbelt retractor 202 and into the field of view of the proximity sensor 302. The proximity sensor 302 is positioned in the seatbelt retractor 202 and the detection strip 304 is positioned on the seatbelt 200 so that when the seatbelt 200 is worn by the occupant the detection strip 304 is exposed and may be detected in the field of view of the proximity sensor 302. The proximity sensor 302 and the detection strip 304 may be further configured and calibrated so that the proximity sensor 302 detects the detection strip 304 when the seatbelt 200 is properly worn by an occupant of the work machine 100. The detection strip 304 may also enter and exit the seatbelt retractor 202 with the seatbelt 200 for exposing itself to the proximity sensor 302 during proper seatbelt usage. The detection strip 304 may be provided at varying degrees of length to support varying configurations.

The tension sensor 604 may also be provided on the seatbelt 200 proximate or close to the seatbelt retractor 202 to measure the tension of the seatbelt 200 shown as a lap belt in FIG. 8. If the tension of the seatbelt 200 falls below a certain tension threshold, then the tension sensor 604 may detect that the seatbelt 200 is not worn over the occupant. If the tension of the seatbelt 200 is detected above a certain tension threshold, then the tension sensor 604 may detect that the seatbelt 200 is buckled over the occupant. The tension sensor 604 incorporated with the seatbelt 200 closer to the seatbelt retractor 202 supports in detecting pseudo buckling and detection of routing the seatbelt 200 along the backside of the seat 112, because the tension sensor 604 may be configured to determine a backside tension threshold when the seatbelt 200 is placed on the backside of the seat 112, as shown in FIG. 7.

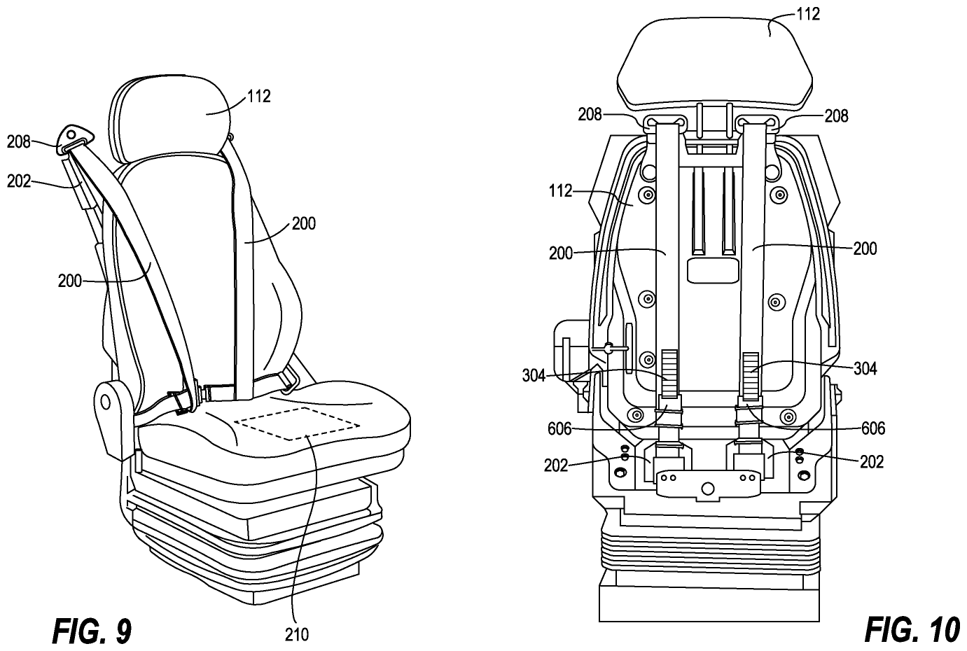

Referring now to FIGS. 9 and 10, the seat 112 is illustrated with the seatbelt 200 shown as a shoulder belt, in another embodiment of the disclosure. The seatbelt 200 is provided from the rear side of the seat 112, shown in FIG. 10, and extends above the shoulders of the seat 112 and buckles into the buckle 206 positioned on the front side of the seat 112, shown in FIG. 9. The shoulder belt type seatbelt 200 is worn across the shoulders and chest of an occupant, as generally known in the arts. The shoulder belt type seatbelt 200 may utilize more than one seatbelt retractor 202, more than one proximity sensor 302, more than one tension sensor 604, and/or more than one integrated sensor 606, applied to each strap of the seatbelt 200 for each shoulder.

When the occupant wears the seatbelt 200 and buckles the latch plate 204 into the buckle 206, the detection strip 304 on the seatbelt 200 extends out of the seatbelt retractor 202 from the rear side of the seat 112 and into the field of view of the integrated sensor 606. The integrated sensor 606 may be provided in the seatbelt retractor 202 and the detection strip 304 may be positioned on each strap of the shoulder type seatbelt 200 so that when the seatbelt 200 is worn by the occupant the detection strip 304 is exposed and may be detected in the field of view of the integrated sensor 606. The integrated sensor 606 and the detection strip 304 may be further configured and calibrated so that the integrated sensor 606 detects the detection strip 304 when the seatbelt 200 is properly worn by an occupant of the work machine 100. The detection strip 304 may also enter and exit the seatbelt retractor 202 with the seatbelt 200 for exposing itself to the integrated sensor 606 during proper seatbelt usage. The detection strip 304 may be provided at varying degrees of length to support varying configurations.

The integrated sensor 606 may also be provided in the seatbelt retractor 202 to measure the tension of the shoulder type seatbelt 200. If the tension of the seatbelt 200 falls below a certain tension threshold, then the integrated sensor 606 may detect that the seatbelt 200 is not worn over the occupant and buckled. If the tension of the seatbelt 200 is detected above a certain tension threshold, then the integrated sensor 606 may detect that the seatbelt 200 is buckled over the occupant. The integrated sensor 606 incorporated with the seatbelt retractor 202 supports in detecting pseudo buckling because the integrated sensor 606 may be configured to determine a tension threshold when the seatbelt 200 is placed on the occupant. The shoulder type seatbelt 200 may also be referred a sash-type seatbelt 200.

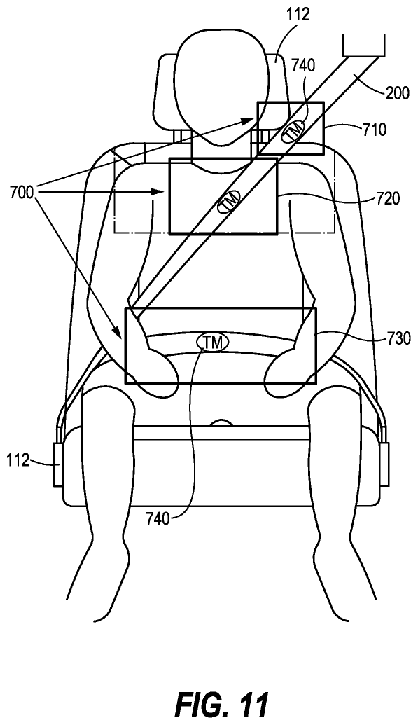

Referring now to FIG. 11, a front view of the seat 112 with the seatbelt 200 from the vantage point of the imaging device 114 in the work machine 100 is illustrated, according to an embodiment of the disclosure. The imaging device 114 may be a plurality of stereo cameras, video cameras, smart cameras, monocular cameras, wired ethernet cameras with high compute PGA, or smart vision systems having a dedicated processor onboard, including video processing acceleration provided by Field programmable Gate array (FPGA), digital signal processor (DSP), general purpose graphics processing unit (GP-GPU), or any other suitable microprocessor with supporting application software, capable of detecting persons within the detection zone 118 from images or real-time videos.

The imaging device 114 may process sequences of images to identify proper buckling, proper use, improper use, and pseudo buckling of the seatbelt 200 by an occupant in the work machine 100. The imaging device 114 may include image processing algorithms configured to detect areas indicative of proper buckling of seatbelt. The imaging device 114 can be configured to detect improper, proper, and pseudo buckling events by processing sequences of images from a plurality of detection zones 700 captured by the imaging device 114 during operation of the work machine 100. The plurality of detection zones 700 may include a first detection zone 710 proximate to a shoulder of an occupant, a second detection zone 720 proximate to a chest of an occupant, and a third detection zone 730 proximate to a waist of an occupant. The imaging device 114 may also be configured to utilize night vision capabilities while processing sequences of images from the plurality of detection zones 700, as generally known in the arts of night vision imaging. The imaging device 114 may also be configured to specifically detect fluorescent brand logos 740 embedded on the seatbelt 200. The fluorescent brand logos 740 are used to assist the imaging device 114 in identifying the seatbelt 200. The imaging device 114 and plurality of detection zones 700 to assist the plurality of detection devices 814 to determine proper or improper usage of the seatbelt 200 when processing sequences of images within the plurality of detection zones 700.

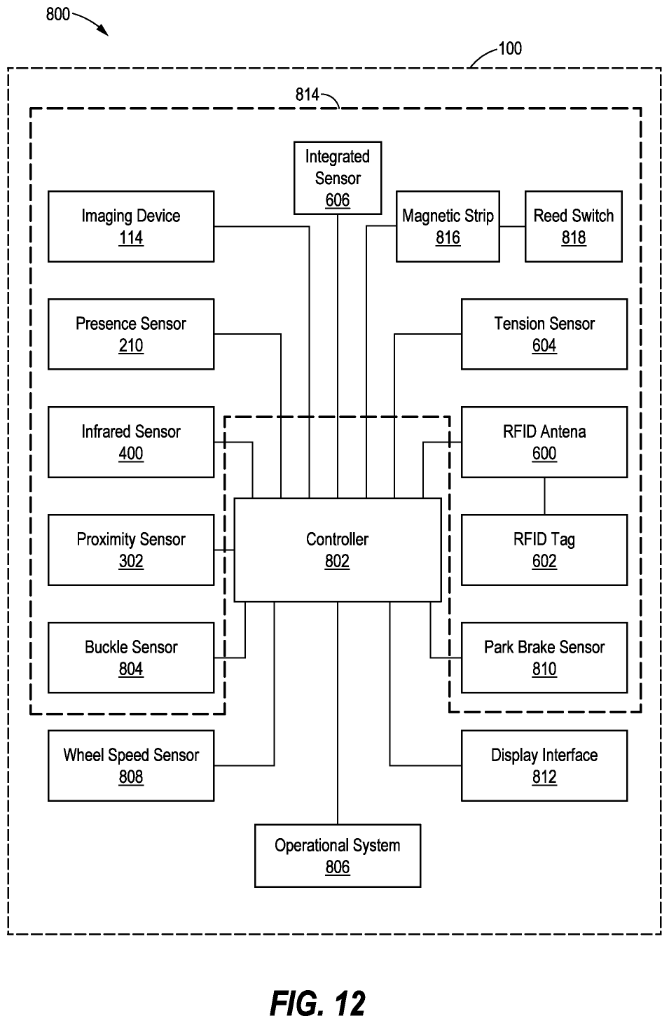

Now referring to FIG. 12, a schematic of the seatbelt usage system 800 in the work machine 100 is illustrated, according to one embodiment of the disclosure. The seatbelt usage system 800 may include a controller 802, the presence sensor 210, the proximity sensor 302, infrared sensor 400, the imaging device 114, the RFID antenna 600, RFID tag 602, the tension sensor 604, the integrated sensor 606, and a buckle sensor 212. The seatbelt usage system 800 may further include operational systems 806, a wheel speed sensor 808, a park brake sensor 810, and a display interface 812. The buckle 206 may include the buckle sensor 212 for detecting when the latch plate 204 has been buckled inside the buckle 206 to secure a locked engagement of the seatbelt 200 against an occupant for ensuring proper seatbelt usage by the occupant during an operation of the work machine 100.

The controller 802 in the work machine 100 may control operational systems 806 associated with the work machine 100. The operational systems 806 may be one of many operating systems found within a work machine 100 such as an ignition system, a fuel injection system, an oil transport system, a transmission, a throttle system, a power system, a braking system, a cooling system, a navigation system, a lighting system, an alarm system, a battery system, and/or an engine or other propulsion system, as generally known in the arts. These systems may also include one or more hydraulic, mechanical, electronic, and software-based components in which the controller 802 may communicate with and control, as generally known in the arts. A mobile remote may be used to communicate with the controller 802, via an off-board network, to control, activate, or deactivate the operational systems 214, controller 802, and seatbelt usage system 800 within the work machine 100.

The work machine 100 may use the presence sensor 210 for detecting when an occupant is on the seat 112 while also using a plurality of detection devices 814 that includes the proximity sensor 302, the infrared sensor 400, the imaging device 114, the RFID antenna 600, RFID tag 602, the tension sensor 604, the integrated sensor 606, and the buckle sensor 212 for detecting when the occupant is wearing the seatbelt 200 properly, improperly, or by pseudo buckling while seated on the seat 112. The controller 802 may receive signals from the proximity sensor 302, the infrared sensor 400, the imaging device 114, the RFID antenna 600, RFID tag 602, the tension sensor 604, the integrated sensor 606, and the buckle sensor 212 for detecting proper usage of the seatbelt 200 in the cab 108 while the work machine 100 is operating. The controller 802 may also receive signals from the presence sensor 210 when an occupant is seated on the seat 112. The signals received by the controller 802 may be communicated by the sensors when the seatbelt 200 is placed behind an occupant along the front side of the seat 112 or along the backside of the seat 112, even when the latch plate 204 is engaged in the buckle 206 which is detectable by the buckle sensor 212 and communicated to the controller 802. The RFID antenna 600 communicates signals to the controller 802 when the RFID antenna 600 detects or receives a signal from the RFID tag 602. A magnetic strip 816 and a Reed switch 818 may replace the RFID antenna 600 and RFID tag 602, respectively, and may communicate with the controller 802. The magnetic strip 816 and Reed switch 818 may also be included with the plurality of detection devices 814 and work simultaneously with each of the plurality of detection devices 814.

Data collected by the controller 802 may be communicated to an on-board controller to alert a central operator or owner of the work machine 100. The controller 802 may also store the data of proper seatbelt usage, improper seatbelt usage, and pseudo buckling to record data on a specific occupant's operation within the work machine 100. The controller 802 may also alert a central operator of proper and improper use of the seatbelt 200 by an occupant during operation of the work machine 100.

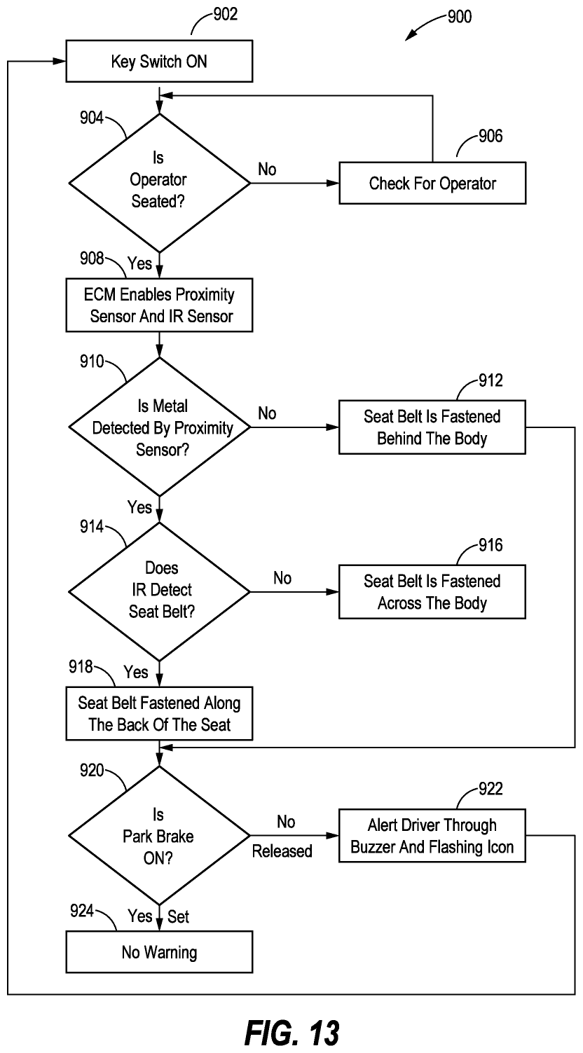

Now referring to FIG. 13, a flow chart of a first detection operation 900 of the seatbelt usage system 800 in the work machine 100 is illustrated, according to one embodiment of the disclosure. In a step 902, a key ignition switch is turned on to activate the work machine 100. In a step 904, the controller 802 determines if an operator is seated on the seat 112 via the presence sensor 210. In a step 906, the presence of the operator is checked by the presence sensor 210 and will continue to be monitored until an operator is seated on the seat 112. In a step 908, when the engine 106 is activated, the controller 802, or via an engine controller module (ECM), enables the proximity sensor 302 and the infrared sensor 400.

In a step 910, the proximity sensor 302 continuously detects for the detection strip 304, or tape, which may be a metal strip made of ferrous metal within the seatbelt 200. In a step 912, the proximity sensor 302 communicates a signal to the controller 802 that the seatbelt 200 is fastened behind the occupant. In a step 914, the infrared sensor 400 simultaneously detects for the seatbelt 200. In a step 916, the infrared sensor 400 communicates a signal to the controller 802 that the seatbelt 200 may be fastened across the occupant, if the infrared sensor 400 does not detect the seatbelt 200. In a step 918, if the infrared sensor 400 detects the seatbelt 200, then the controller 802 receives a signal that the seatbelt 200 is fastened along the back side of the seat 112. When the controller 802 receives a signal that the seatbelt 200 is fastened behind the occupant, in the step 912, or, when the controller 802 receives a signal that the seatbelt 200 is fastened behind the seat 112, in a step 918, the controller 802 may subsequently activate or deactivate at least one of the operational systems 806.

For example, the controller 802 may determine if a park brake, via the park brake sensor 810, is ON, in a step 920. If the park brake is off, then the occupant will be alerted through a buzzer, flashing icon, and the like, on the display interface 812 or a dashboard system of the work machine 100, in a step 922. If the park brake is ON, in a step 924, the controller 802 will deactivate the ignition system and terminate the power from the work machine 100. In another example, the controller 802 may determine if the work machine 100 is moving, via the wheel speed sensor 808, which may communicate to the controller 802 the speed of the ground engaging elements 104. If the wheel speed sensor 808 communicates to the controller 802 that the work machine 100 is moving, the controller 802 may communicate to the engine control unit and a transmission controller, if equipped, to slow the work machine 100 down to a halt.

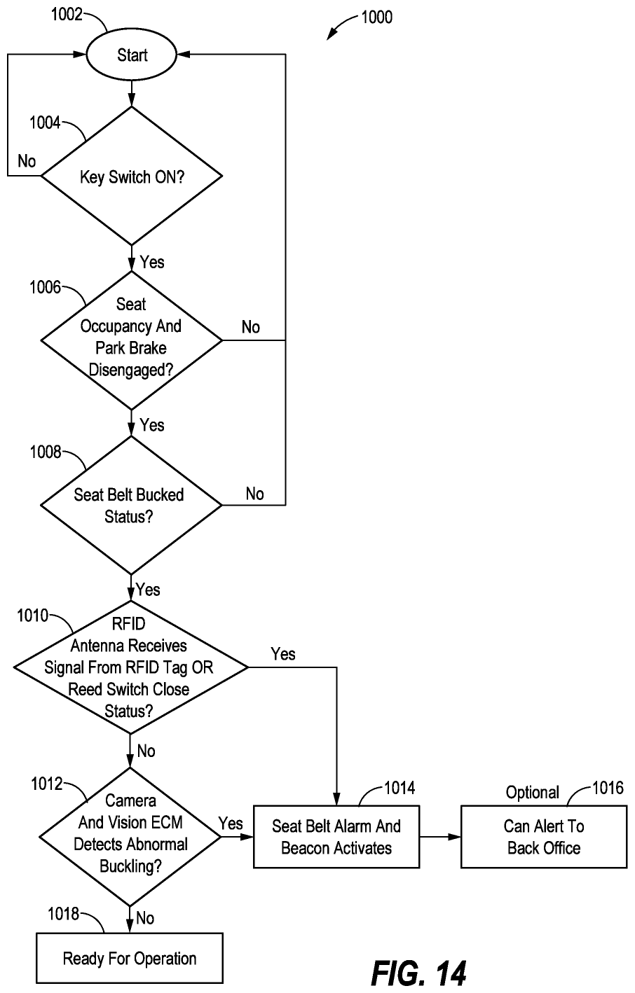

Now referring to FIG. 14, a flow chart of a second detection operation 1000 of the seatbelt usage system 800 in the work machine 100 is illustrated, according to another embodiment of the disclosure. In a step 1002, the work machine 100 is activated, and the key ignition status is determined by the controller 802, in a step 1004. If the key ignition switch is turned on, then the controller 802 detects whether there is an occupant on the seat 112 and if the park brake of the work machine 100, via the park brake sensor 810, is disengaged, in a step 1006. The controller 802 will receive signals from the presence sensor 210 in the seat 112 for when an occupant is seated. If an occupant is seated on the seat 112 and park brake is disengaged, then the controller 802 determines if the seatbelt 200 is buckled via the buckle sensor 212, in a step 1008. If the seatbelt 200 is buckled, then the RFID antenna 600 may receive a signal from the RFID tag 602, in a step 1010. As an alternative, the RFID antenna 600 and the RFID tag 602 may be replaced by the Reed switch 818 and the magnetic strip 816.

In a step 1012, the imaging device 114 may process images of the occupant wearing the seatbelt 200 while seated on the seat 112 and detect for abnormal buckling by the plurality of detection zones 700. If the imaging device 114 detects abnormal buckling then the controller 802 may activate operational systems 806 such as lighting systems, such as beacon lights, tell-tales, etc., and alarm systems of the work machine 100. For example, if the imaging device detects abnormal pseudo buckling of the seatbelt 200, the controller 802 may activate a seatbelt alarm and beacon light, as shown in a step 1014. Subsequently, in a step 1016 the controller 802 may alert a central server or other off-board networks, as generally known in the arts. If the imaging device 114 and the RFID antenna 600 or Reed switch 818 do not detect the abnormal, improper, or pseudo seatbelt buckling, then the work machine 100 is ready for operation, as shown in step 1018.

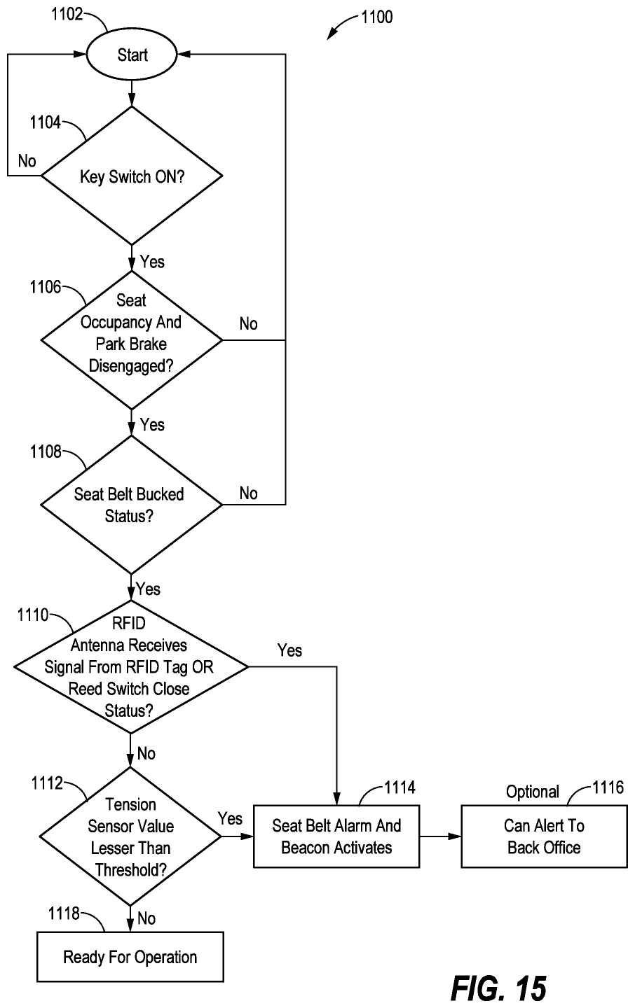

Now referring to FIG. 15, a flow chart of a third usage detection operation 1100 of the seatbelt usage system 800 in the work machine 100 is illustrated, according to another embodiment of the disclosure. In a step 1102, the work machine 100 is activated, and the key ignition status is determined by the controller 802, in a step 1104. If the key ignition switch is turned on, then the controller 802 detects whether there is an occupant on the seat 112 and if the park brake of the work machine 100 is disengaged, in a step 1106. The controller 802 will receive signals from the presence sensor 210 in the seat 112 when an occupant sits on the seat 112 due to the downward pressure applied to the seat. If an occupant is seated on the seat 112 and the work machine 100 park brake is disengaged, then the controller 802 determines if the seatbelt 200 is buckled via the buckle sensor 212, in a step 1108. If the seatbelt 200 is buckled, then the RFID antenna 600 or Reed switch 818 may receive a signal from the RFID tag 602 or magnetic strip 816, respectively, in a step 1110.

In a step 1112, the tension sensor 604 detects for whether the tension on the seatbelt 200 is below a certain tension threshold and may activate operational systems 806 such as lighting systems, such as beacon lights, tell-tales, etc., and alarm systems of the work machine 100, in a step 1114. For example, if the tension sensor 604 detects abnormal tension of the seatbelt 200, the controller 802 may activate a seatbelt alarm and beacon light, as shown in a step 1114. Subsequently, in a step 1116 the controller 802 may alert a central server or other off-board networks, as generally known in the arts. If the tension sensor 604 and the RFID antenna 600 or Reed switch 818 do not detect the abnormal or improper seatbelt buckling, then the work machine 100 is ready for operation, as shown in step 1118.

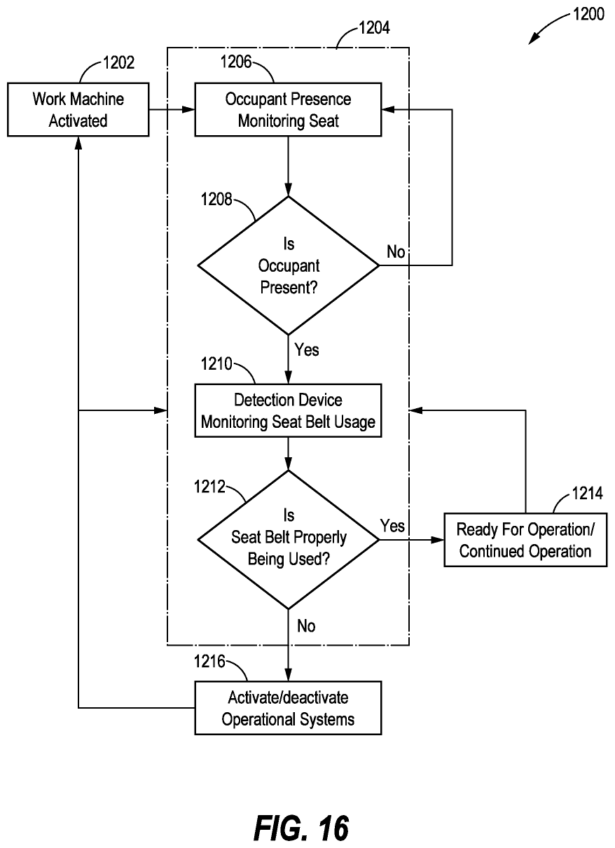

Now referring to FIG. 16, a flow chart of a fourth detection operation 1200 of the seatbelt usage system 800 in the work machine 100 is illustrated, according to another embodiment of the disclosure. FIG. 16 demonstrates the first detection operation 900, second detection operation 1000, and third detection operation 1100 may be combined in a variety of ways to ensure proper seatbelt usage by an occupant in a work machine 100.

In a step 1202, the work machine 100 is activated. Subsequently, the seatbelt usage system 800 is activated, in a step 1204. The seatbelt usage system 800 may be activated upon an engine start activation or when the work machine 100 is initially powered on, as generally known in the arts. In a step 1206, seatbelt usage system 800 monitors for an occupant being present on the seat 112 via the presence sensor 210. In a step 1208, the controller 802 will continuously receive signals from the presence sensor 210 when detecting the presence of an occupant seated on the seat 112. If an occupant is seated on the seat 112, then the seatbelt usage system 800 will detect for proper usage of the seatbelt 200 via the controller 802 and the plurality of detection devices 814. The plurality of detection devices 814 communicate signals to the controller 802 when the occupant is properly using, improperly using, or pseudo buckling the seatbelt 200, even when the seatbelt 120 is buckled in the buckle 206, in a step 1212. If the seatbelt 200 is properly being used, then the seatbelt usage system 800 will allow the work machine 100 to be ready for operation or continue operating, in a step 1214. If the seatbelt 200 is improperly being used, then the seatbelt usage system 800 will communicate to one of the operational systems 806 to activate or deactivate.

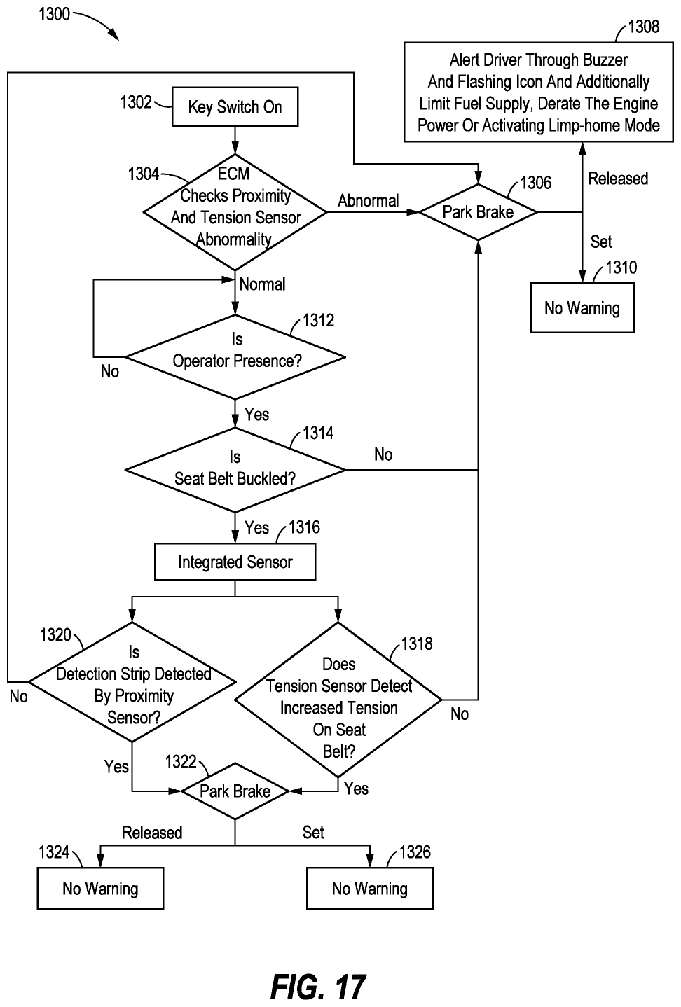

Now referring to FIG. 17, a flow chart of a fifth detection operation 1300 of the seatbelt usage system 800 in the work machine 100 is illustrated, according to another embodiment of the disclosure. In a step 1302, a key ignition switch is turned on to activate the work machine 100. In a step 1304, when the engine 106 is activated, the controller 802, or via an engine controller module (ECM), checks for the proximity sensor 302 and the tension sensor 602, which may also be the integrated sensor 606. If in the step 1403 there are abnormal signals from the proximity sensor 302, the tension sensor 604, and/or the integrated sensor 606, then the controller 802 will check the status of the park brake via the park brake sensor 810, in a step 1306.

If the park brake is RELEASED, in a step 1308, then the operator/passenger may be alerted through a buzzer, a flashing icon, or additional measures may be taken by the controller 802 to limit fuel supply, derate the power of the engine 106, and/or activate a limp-home mode, as generally known in the arts. If the park brake is SET, then no warning will be displayed or alerted to the operator/passenger on the seat 112, as shown in a step 1310.

In a step 1312, the controller 802 determines if an operator is seated on the seat 112 via the presence sensor 210. In the step 1312, the presence of the operator is checked by the presence sensor 210 and will continue to be monitored until an operator is seated on the seat 112. If an occupant is seated on the seat 112 and the work machine 100 park brake is disengaged, then the controller 802 determines if the seatbelt 200 is buckled via the buckle sensor 212, in a step 1314. If the buckle sensor 212 signals that the seatbelt 200 is not buckled, then the controller 802 may check for the status of the park brake, in step 1306, and determine if the park brake is SET or RELEASED in steps 1310 and 1308.

If the buckle sensor 212, in step 1314, signals the seatbelt 200 is buckled, then the controller 802 will check for received signals of the for the proximity sensor 302 and the tension sensor 602, which is the integrated sensor 606, in a step 1316. In a step 1318, the controller 802 receives signals from the tension sensor 602 which is the integrated sensor 606 for determining whether the tension sensor 602 detects an increased tension on the seatbelt 200 when it is buckled. In a step 1320, the controller 802 receives signals on whether the proximity sensor 302 which is the integrated sensor 606 detects the detection strip 304. If the controller 802 receives signals detecting the detection strip 304 and an increased tension from the proximity sensor 302 and the tension sensor 602, respectively, which are the integrated sensor 606, in steps 1318 and 1320, then the controller 802 will check for the status of the park brake on the work machine 100 via the park brake sensor 810 in a step 1322. The controller 802 will not issue any warning to the operator or passenger if the park brake sensor 810 communicates that the park brake is RELEASED, in a step 1324, or SET, in a step 1326.

However, if in either step 1318 or 1320 the proximity sensor 302, the tension sensor 602, which is the integrated sensor 606 do not communicate a signal to the controller 802 detecting the detection strip 304 or an increased tension on the seatbelt 200, then the controller 802 will communicate with the park brake sensor 810 for the SET or RELEASED status of the park brake, as shown in step 1306. If the park brake is RELEASED, then the operator/passenger may be alerted through a buzzer, a flashing icon, or additional measures may be taken by the controller 802 to limit fuel supply, derate the power of the engine 106, and/or activate a limp-home mode, an ignition shut-off control procedure, a machine ignition relay operation, an alert on a dashboard system, a transmission speed reduction mode, a wheel speed reduction mode, and a derate hydraulic operation, as generally known in the arts, as shown in 1308. If the park brake is SET, then no warning will be displayed or alerted to the operator/passenger on the seat 112, as shown in step 1310.

The first detection operation 900, second detection operation 1000, third detection operation 1100, fourth detection operation 1200, and fifth detection operation 1300 each demonstrate how the seatbelt usage system 800 detects for proper use of the seatbelt 200 by an occupant in the work machine 100. The first detection operation 900, second detection operation 1000, third detection operation 1100, fourth detection operation 1200, and fifth detection operation 1300 detect for when the seatbelt 200 is improperly worn or pseudo buckling has occurred when: (1) the seatbelt is placed behind an occupant's body along the front side of the seat 112; (2) the seatbelt is wrapped along the backside of the seat 112; and/or (3) a dummy latch plate is inserted into the buckle 206.

The controller 802 may store data when an occupant has been detected to use the seatbelt 200 properly and/or improperly. Furthermore, each time the seatbelt usage system 800 detects an instance of improper use of the seatbelt 200 during operation of the work machine 100, the controller 802 may alert an off-board central server for alerting the owner of the work machine 100.

The embodiments disclosed allow for detection of improper seatbelt usage and does not get interfered with occupants who may have a medically required pacemaker. For example, the embodiment using the integrated sensor 606 as the strategic location 306 would allow for detection of improper seatbelt usage regardless if the occupant on the seat 112 has a medically required pacemaker.

### INDUSTRIAL APPLICABILITY

In operation, the present disclosure may find applicability in many industries including, but not limited to, the automotive, construction, earth-moving, mining, and agricultural industries. Specifically, the technology of the present disclosure may be used for maintaining proper seatbelt usage during operation of work machines including, but not limited to, excavators, backhoes, skid steers, wheel loaders, tractors, and the like. While the foregoing detailed description is made with specific reference to backhoe loaders, it is to be understood that its teachings may also be applied onto the other work machines and vehicles such as cars, SUVs, trucks, buses, electric vehicles, electric machines, construction equipment such as excavators, skid steers, wheel loaders, mulchers, farm equipment such as tractors, harvesters, and the like. The seatbelt usage system 800 may be provided as a retrofit onto these other applications.

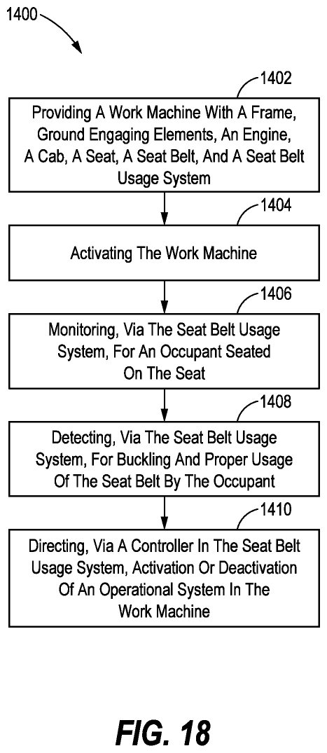

Now referring to FIG. 18, a method for detecting pseudo buckling 1400 during operation of the work machine 100 is shown, according to one embodiment of the disclosure. In a step 1402, the work machine 100 is provided with the frame 102, the ground engaging elements 104 supporting the frame 102, the engine 106, the cab 108, the seat 112, and the seatbelt usage system 800. In a step 1404, the work machine 100 is activated, thereby activating the engine 106 and/or other operational system 806 such as a battery system.

In a step 1406, the seatbelt usage system 800 monitors for an occupant present on the seat 112. In a step 1408, the plurality of detection devices 814 detect for buckling and pseudo buckling of the seatbelt 200 by the occupant. The plurality of detection devices 814 may detect: (1) when the occupant is present on the seat 112; (2) when the seatbelt 200 has not been pulled; (3) when the seatbelt 200 has not been buckled in the buckle 206 via the latch plate 204; (4) when the seatbelt 200 has been buckled but is between the backside of the operator and along the front side of the seat 112; (5) when the seatbelt 200 has been buckled but is along the back side of the seat 112; and (6) when a dummy latch plate is inserted or engaged to the buckle 206.

In a step 1410, the controller 802 directs activation or deactivation of one of the operation systems 806 in the work machine 100 to alert the occupant, driver, operator, and/or owner that improper use of the seatbelt 200 is occurring during operation of the work machine 100. The controller 802 may restrict operation of the work machine 100 in step 1410.

The seatbelt usage system 800 may also be configured to detect whether an occupant is properly using the seatbelt 200 and detect whether the occupant is wearing a construction vest that includes the detection strip 304, the RFID tag 602, and/or the Reed switch 818.

From the foregoing, it can be seen that the technology disclosed herein has industrial applicability in a variety of settings such as, but not limited to, ensuring proper use of the seatbelt 200 during operation of the work machine 100.

1.-14. (canceled)

15. A system for detecting improper use of a seatbelt on a seat in a work machine, the system comprising:
a plurality of detection devices disposed on a plurality of locations within a cab of the work machine;
a detection strip/tape on a strategic location of the seatbelt and configured to be detected by the plurality of detection devices;
a controller coupled in communication to the plurality of detection devices, the controller configured to:
receive input signals from the plurality of detection devices, wherein at least one input signal is indicative of improper use of the seatbelt; and
communicate control signals to at least one operational system associated with the work machine upon receipt of an at least one input signal indicative of improper use of the seatbelt.

16. The system of claim 15, wherein the controller is configured to determine from the at least one input signal indicative of improper use of the seatbelt if:
an occupant is not present on the seat and if:
the seatbelt has been pulled;
the occupant is present on the seat and if:
the seatbelt has not been pulled;
a tongue/latch of the seatbelt is not engaged with a buckle;
the seatbelt is routed between a back side of an occupant's body and a front side of the seat;
the seatbelt has been routed along a back side of the seat; and
the tongue/latch not associated with the seatbelt is engaged to the buckle.

17. The system of claim 16, wherein the detection strip/tape is at least one of a ferrous strip/tape, a magnetic strip, and a Radio Frequency Identification (RFID) tag.

18. The system of claim 17, the system further comprising a retractor and wherein the plurality of detection devices includes an occupant presence sensor in the seat, a buckle sensor disposed in the buckle, and at least one of:
a proximity sensor mounted on a support substrate disposed proximate to the seatbelt and includes one of the following:
a tension sensor provided on the seatbelt and located at a pre-determined distance from the retractor;
an infrared (IR) sensor provided proximate to the back side of the seat;
an Integrated sensor (Proximity cum Tension sensor) provided on the seatbelt and located at a pre-determined distance from the retractor;
a Reed switch provided on a backrest portion of the seat and a magnetic strip provided on the seatbelt, and the tension sensor is provided on the seatbelt and located at a pre-determined distance from the retractor;
an RFID antenna provided proximate to the seat and an RFID tag provided on the seatbelt, and the tension sensor is provided on the seatbelt and located at a pre-determined distance from the retractor; and
an image processing device (display/controller) in the work machine.

19. The system of claim 18, wherein if the detection strip/tape is the ferrous strip/tape, then the plurality of detection devices includes:
the proximity sensor, wherein the proximity sensor is configured to detect a presence of the detection strip/tape; and
the tension sensor, wherein the tension sensor is configured to determine a magnitude of tension on the seatbelt.

20. The system of claim 19, wherein the plurality of detection devices comprises at least one of:
the IR sensor, wherein the IR sensor is provided on the back side of the seat and configured to determine if the seatbelt is routed along the back side of the seat;
the Reed switch provided in the backrest portion of the seat and the magnetic strip is provided on the seatbelt;
the RFID antenna provided in the backrest portion of the seat and the RFID tag provided on the seatbelt; and
the image processing device (display/controller) is provided in the cab of the work machine and configured to process images of the seat and the seatbelt.

21. The system of claim 20, wherein the at least one operational system includes at least one of:
an ignition system;
a prime mover including at least one of:
an engine system;
an electric motor system;
an alarm system;
a lighting system;
a display interface in the work machine;
a dashboard system of the work machine;
a ground engaging system; and
a park brake system.

22. The system of claim 21, wherein the controller is configured to determine if the work machine is in an OFF state or an ON state including one of: idling, moving, active, standstill, operating, and charging.

23. The system of claim 22, wherein the controller further communicates to the at least one operational system to activate at least one of the following operations in the work machine:
an alerting buzzer;
a flashing icon on the display interface;
a limp-home mode;
a fuel limiting supply mode;
a transmission speed reduction mode;
a wheel speed reduction mode;
derate hydraulics operation; and
an alert on the dashboard system.

24. The system of claim 19, wherein the proximity sensor and the tension sensor are mounted on the seatbelt closer to the retractor configured to retract the seatbelt, and the retractor is positioned proximate to the seat.

25. The system of claim 19, wherein the detection strip/tape is provided on the seatbelt by one of: embedded within a series of layers of the seatbelt, camouflaged with similar colors as the seatbelt, applied fluorescently on the seatbelt, affixed to the top side of the seatbelt, affixed to the bottom side of the seatbelt, and concealed by using an additional layer that is stitched with the seatbelt.

26. A work machine comprising:
a frame;
a prime mover mounted on the frame including at least one of:
an engine system and an electric motor system;
a ground engaging system supporting the frame;
a cab;
a seat;
a seatbelt having a latch plate configured to connect to a buckle;
a retractor coupled to the seatbelt;
a detection strip/on a portion of the seatbelt;
a plurality of detection devices disposed on a plurality of locations within the cab of the work machine;
a controller communicably coupled to the plurality of detection devices, the controller configured to:
receive input signals from the plurality of detection devices wherein at least one input signal is indicative of improper use of the seatbelt; and
communicate control signals to at least one operational system associated with the work machine upon receipt of an at least one input signal indicative of improper use of the seatbelt.

27. The work machine of claim 26, wherein the controller is configured to determine from the at least one input signal indicative of improper use of the seatbelt if:
an occupant is not present on the seat and if:
the seatbelt has been pulled;
the occupant is present on the seat and if:
the seatbelt has not been pulled;
a tongue/latch of the seatbelt is not engaged with the buckle;
the seatbelt is routed between a back side of an occupant's body and a front side of the seat;
the seatbelt has been routed along a back side of the seat; and
the tongue/latch not associated with the seatbelt is engaged to the buckle.

28. The work machine of claim 27, wherein the detection strip/tape is at least one of the ferrous strip/tape, a magnetic strip, and a Radio Frequency Identification (RFID) tag.

29. The work machine of claim 28, wherein the plurality of detection devices includes an occupant presence sensor in the seat, a buckle sensor disposed in the buckle, and at least one of:
a proximity sensor mounted on a support substrate disposed proximate to the seatbelt and at least one of the following:
a tension sensor provided on the seatbelt and located at a pre-determined distance from the retractor;
an infrared (IR) sensor provided proximate to the back side of the seat;
an Integrated sensor (Proximity cum Tension sensor) provided on the seatbelt and located at a pre-determined distance from the retractor;
a Reed switch provided on a backrest portion of the seat and a magnetic strip provided on the seatbelt, and the tension sensor is provided on the seatbelt and located at a pre-determined distance from the retractor;
an RFID antenna provided proximate to the seat and an RFID tag provided on the seatbelt, and the tension sensor is provided on the seatbelt and located at a pre-determined distance from the retractor; and
an image processing device (display/controller) in the work machine.

30. The work machine of claim 29, wherein if the detection strip/tape is the ferrous strip/tape, then the plurality of detection devices includes:
the proximity sensor, wherein the proximity sensor is configured to detect a presence of the detection strip/tape; and
the tension sensor, wherein the tension sensor is configured to determine a magnitude of tension on the seatbelt.

31. The work machine of claim 30, wherein:
the plurality of detection devices optionally includes any of the following:
the IR sensor is provided on a back side of the seat and configured to determine if the seatbelt is routed along the back side of the seat;
the Reed switch provided proximate to the seat and the detection strip comprises the magnetic strip;
the RFID antenna provided proximate to the seat and the detection strip comprises the RFID tag; and
the image processing device (display/controller) is provided in the cab of the work machine and configured to process images of the seat and the seatbelt.

32. The work machine of claim 28, wherein the at least one operational system being at least one of:
an ignition system;
an engine system;
the electric motor system;
an alarm system;
a lighting system;
a display interface;
a dashboard system of the work machine;
the ground engaging system; and
a park brake system.

33. The work machine of claim 32, wherein the controller is configured to determine if the work machine is in an OFF state or an ON state including one of: idling, moving, active, standstill, operating, and charging.

34. The work machine of claim 33, wherein the controller further communicates to the at least one operational system to activate at least one of the following operations in the work machine:
an alerting buzzer;
a flashing icon on the display interface;
a limp-home mode;
a fuel limiting supply mode;
a transmission speed reduction mode;
a wheel speed reduction mode;
derate hydraulics operation; and
an alert on the dashboard system.

35. The work machine of claim 34, wherein the proximity sensor and the tension sensor are mounted on the seatbelt closer to the retractor configured to retract the seatbelt, and the retractor is positioned proximate to the seat.

36. The work machine of claim 29, wherein the detection strip is provided on the seatbelt by one of: embedded within a series of layers of the seatbelt, camouflaged with similar colors as the seatbelt, applied fluorescently on the seatbelt, affixed to the top side of the seatbelt, affixed to the bottom side of the seatbelt, and concealed by using an additional layer that is stitched with the seatbelt.

37. A method for detecting improper use of a seatbelt by an occupant in a work machine, the method comprising:
providing a seatbelt usage system to a seat in the work machine;
activating the work machine to an operational state thereby activating the seatbelt usage system;
monitoring, via an occupant presence sensor in the seatbelt usage system, for the occupant seated on the seat;
detecting, via a plurality of detection devices in the seatbelt usage system for improper use of the seatbelt; and
controlling an operational system, via a controller in the seatbelt usage system, to enforce proper usage of the seatbelt.

38. The method of claim 37, the method further comprising determining, via the controller, if the work machine is in an OFF state or an ON state including one of: idling, moving, active, standstill, operating, and charging.

39. The method of claim 38, further comprising:
detecting, via the plurality of detection devices in the seatbelt usage system, for improper use of the seatbelt including if:
an occupant is not present on the seat and if:
the seatbelt has been pulled;
the occupant is present on the seat and if:
the seatbelt has not been pulled;
a tongue/latch of the seatbelt is not engaged with a buckle;
the seatbelt is routed between a back side of an occupant's body and a front side of the seat;
the seatbelt has been routed along a back side of the seat; and
the tongue/latch not associated with the seatbelt is engaged to the buckle.

40. The method of claim 39, further comprising:
providing the work machine with a wheel speed sensor and a park brake sensor on the work machine, the wheel speed sensor and park brake sensor are communicably connected to the controller;
detecting, via the controller, to determine mobility status of the work machine;
communicating, via the controller, to the at least one operational system to conduct at least one of:
an alerting buzzer on a dashboard system in the work machine;
a flashing icon on a display interface in the work machine;
a limp home mode:
a fuel limiting supply mode;
a transmission speed reduction mode;
a wheel speed reduction mode;
derate hydraulics operation; and
an alert on the dashboard system.

41. The method of claim 40, further comprising:
providing, in the plurality of detection devices, the occupant presence sensor in the seat, a buckle sensor disposed in the buckle, and at least one of:
a proximity sensor mounted on a support substrate disposed proximate to the seatbelt and at least one of the following:
a tension sensor provided on the seatbelt and located at a pre-determined distance from the retractor;
an infrared (IR) sensor provided proximate to the back side of the seat;
an Integrated sensor (Proximity cum Tension sensor) provided on the seatbelt and located at a pre-determined distance from the retractor;
a Reed switch provided on a backrest portion of the seat and a magnetic strip provided on the seatbelt, and the tension sensor is provided on the seatbelt and located at a pre-determined distance from the retractor;
an RFID antenna provided proximate to the seat and an RFID tag provided on the seatbelt, and the tension sensor is provided on the seatbelt and located at a pre-determined distance from the retractor; and
an image processing device (display/controller) in the work machine.
